(19) United States
(12) Patent Application Publication
(10) Pub. No.: US 2026/0367672 A1
(43) Pub. Date: Nov. 19, 2026

(54) ELECTRONIC DEVICE, METHOD OF MANUFACTURING ELECTRONIC DEVICE, AND GUIDE FILM

(71) Applicant: Samsung Display Co., LTD., Yongin-si (KR)

(72) Inventors: DONG-SU YEE, Yongin-si (KR); YOUNGWOON KIM, Yongin-si (KR)

(21) Appl. No.: 19/564,724

(22) Filed: Mar. 12, 2026

(30) Foreign Application Priority Data
May 19, 2025 (KR) 10-2025-0064695

(51) Int. Cl. G06F 1/16

(52) U.S. Cl. CPC G06F 1/1652; G06F 1/163; G06F 2200/1613; G06F 2200/1634

(57) ABSTRACT

A method of manufacturing an electronic device includes preparing a display panel including a bending area and a sub-area adjacent to the bending area, providing a flexible circuit board on the display panel in the sub-area, providing a data driver on the display panel in the sub-area, providing a cover film on the flexible circuit board to cover the data driver and to overlap the bending area of the display panel, , providing a guide film under the display panel to overlap the bending area and the data driver in a plan view, providing a window having a dome shape on the display panel, combining the display panel and the window with each other, and removing the guide film.

### CROSS-REFFERENCE TO A RELATED APPLICATION

This application claims priority to Korean Patent Application No. 10-2025-0064695, filed on May 19, 2025, and all the benefits accruing therefrom under 35 U.S.C. §119, the content of which in its entirety is herein incorporated by reference.

### BACKGROUND

### 1. Field

Embodiments of the present disclosure described herein relate to an electronic device, a method of manufacturing an electronic device, and a guide film.

### 2. Description of the Related Art

Various display devices such as liquid crystal displays, organic light emitting displays, electrowetting displays, plasma displays, and electrophoretic displays have been developed as display devices.

In general, the display devices include a display panel having a quadrangular shape. The display panel having a quadrangular shape includes a plurality of gate lines (or scan lines) extending in a row direction, a plurality of data lines extending in a column direction, and a plurality of pixels connected to the gate lines and the data lines. The pixels may receive data voltages through the data lines in response to gate signals received through the gate lines and display gray scales corresponding to the data voltages.

With the recent increase in use of the display devices, not only the display devices having a quadrangular shape but also display devices having various shapes such as circular display devices and elliptical display devices have been developed.

### SUMMARY

Embodiments of the present disclosure provide an electronic device including a display panel in which cracks in a bending area of the display panel are effectively prevented from occurring.

Embodiments of the present disclosure also provide a method of manufacturing an electronic device in which cracks in a bending area are effectively prevented from occurring.

Embodiments of the present disclosure also provide a guide film capable of effectively preventing cracks from occurring in a bending area.

According to an embodiment, a method of manufacturing an electronic device includes preparing a display panel including a bending area and a sub-area adjacent to the bending area, providing a flexible circuit board on the display panel in the sub-area, providing a data driver on the display panel in the sub-area, providing a cover film on the flexible circuit board to cover the data driver and to overlap the bending area of the display panel, providing a guide film under the display panel to overlap the bending area and the data driver in a plan view, providing a window having a dome shape on the display panel, combining the display panel and the window with each other, and removing the guide film.

In an embodiment, the display panel may have a circular shape in the plan view.

In an embodiment, the display panel may further include a display area and a non-display area adjacent to the display area the providing the guide film may include providing the guide film to overlap the display area and the non-display area.

In an embodiment, The providing the guide film may include providing the guide film to overlap a portion of the cover film in the plan view.

In an embodiment, the guide film may have a thickness greater than 0 micrometer (μm) and less than about 50μm.

In an embodiment, the guide film may have a thickness in a range from about 50μm to about 100μm.

In an embodiment, the cover film may include a first portion adjacent to the bending area and having a first width, a second portion extending from the first portion and having a second width, and a third portion extending from the second portion and having a third width, and the first width may decrease as the first portion approaches a center of the display panel.

In an embodiment, each of the second width and the third width may be constant.

In an embodiment, the third width may be smaller than the second width.

According to an embodiment, a guide film includes a first area disposed under a display panel including a bending area and a sub-area adjacent to the bending area and having a circular shape, a second area disposed under the display panel and overlapping the bending area in a plan view, and a third area disposed under the display panel, not overlapping the bending area, and overlapping the sub-area in the plan view.

In an embodiment, the display panel may include a display area and a non-display area adjacent to the display area, and the guide film may overlap the display area and the non-display area in the plan view.

In an embodiment, the third area may overlap a data driver disposed in the sub-area of the display panel in the plan view.

In an embodiment, the guide film may have a thickness greater than 0μm and less than about 50μm.

In an embodiment, the guide film may have a thickness in a range from about 50μm to about 100μm.

In an embodiment, the third area may overlap a cover film overlapping the bending area of the display panel in the plan view.

In an embodiment, the cover film may include a first portion adjacent to the bending area and having a first width, a second portion extending from the first portion and having a second width, and a third portion extending from the second portion and having a third width, and the first width may decrease as the first portion approaches a center of the display panel.

In an embodiment, the second width and the third width may be constant, and the third width may be smaller than the second width.

According to an embodiment, an electronic device includes a display device which displays an image and a processor which processes an image signal and provides the image signal to the display device, where the display device is manufactured by preparing a display panel including a bending area and a sub-area adjacent to the bending area, providing a flexible circuit board on the display panel in the sub-area, providing a data driver on the display panel in the sub-area, providing a cover film on the flexible circuit board to cover the data driver and to overlap the bending area of the display panel, providing a guide film under the display panel to overlap the bending area and the data driver in a plan view, providing a window having a dome shape on the display panel, combining the display panel and the window with each other, and removing the guide film.

### BRIEF DESCRIPTION OF THE DRAWINGS

The above and other features of embodiments of the present disclosure will become apparent by describing in detail embodiments thereof with reference to the accompanying drawings.

FIG. 1 is a block diagram of an electronic device according to an embodiment of the present disclosure.

FIG. 2 illustrates schematic views of electronic devices according to an embodiment of the present disclosure.

FIG. 3 is a view illustrating a wearable electronic device including a display device according to an embodiment of the present disclosure.

FIG. 4 is a view illustrating a plane of the display device of the wearable electronic device illustrated in FIG. 3.

FIG. 5 is a view illustrating, by way of example, a cross section along line I-I′ of the display device illustrated in FIG. 4.

FIG. 6 is a view illustrating, by way of example, a cross section of a display panel illustrated in FIG. 5.

FIG. 7 is an exploded perspective view of the electronic device according to an embodiment of the present disclosure.

FIG. 8 is a plan view of the display panel illustrated in FIG. 5.

FIG. 9 is a front view illustrating a display module in an unfolded state according to an embodiment of the present disclosure.

FIG. 10 is a rear view illustrating the display module in an unfolded state according to an embodiment of the present disclosure.

FIG. 11 is a rear view illustrating the display module in a bent state according to an embodiment of the present disclosure.

FIG. 12 is a view illustrating a cross section along line II-II′ of the display module illustrated in FIG. 11.

FIGS. 13-20 are views illustrating a method of manufacturing an electronic device according to an embodiment of the present disclosure.

FIG. 21 is a rear view illustrating a guide film and a flexible circuit board according to an embodiment of the present disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

In the specification, the expression that a first component (or area, layer, part, portion, etc.) is “connected with” or “coupled to” a second component means that the first component is directly connected with/coupled to the second component or means that a third component is interposed therebetween.

The same reference numerals refer to the same components. Further, in the drawings, the thickness, the ratio, and the dimension of components are exaggerated for effective description of technical contents.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof..

"About" or "approximately" as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, "about" can mean within one or more standard deviations, or within ± 30%, 20%, 10% or 5% of the stated value.

Unless otherwise defined, all terms (including technical terms and scientific terms) used in the specification have the same meaning as commonly understood by those skilled in the art to which the present disclosure belongs. Furthermore, terms such as terms defined in the dictionaries commonly used should be interpreted as having a meaning consistent with the meaning in the context of the related technology and should not be interpreted in overly ideal or overly formal meanings unless explicitly defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present disclosure will be described with reference to the accompanying drawings.

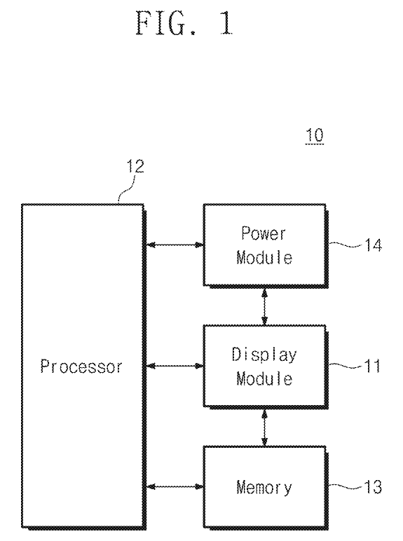

FIG. 1 is a block diagram of an electronic device according to an embodiment of the present disclosure.

Referring to FIG. 1, an electronic device 10 according to an embodiment may include a display module 11 or DM, a processor 12, a memory 13, and a power module 14.

The processor 12 may include at least one selected from a central processing unit (CPU), an application processor (AP), a graphic processing unit (GPU), a communication processor (CP), an image signal processor (ISP), and a controller.

Data information used for operations of the processor 12 or the display module 11 or DM may be stored in the memory 13. When the processor 12 executes an application stored in the memory 13, an image data signal and/or an input control signal may be transmitted to the display module 11 or DM, and the display module 11 or DM may process the received signal and output image information through a display screen.

The power module 14 may include a power supply module such as a power adapter or a battery device and a power conversion module that converts power supplied by the power supply module to generate power used for the operation of the electronic device 10.

At least one of the components of the electronic device 10 may be included in the display device according to an embodiment. Further, some of individual modules functionally included inside one module may be included inside the display device, and the others thereof may be provided separately from the display device. In an embodiment, for example, the display device may include the display module 11 or DM, and the processor 12, the memory 13, and the power module 14 may be provided in the form of other devices in the electronic device 10 rather than the display device.

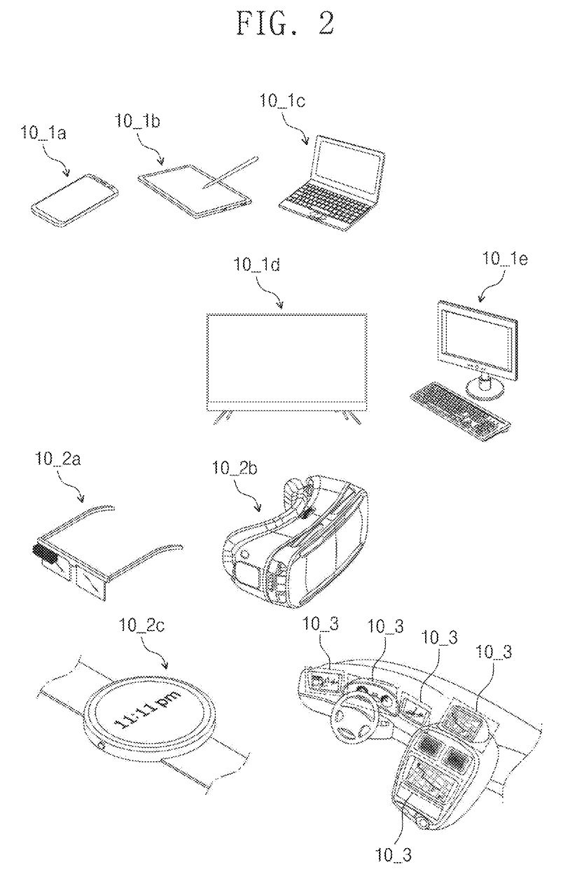

FIG. 2 illustrates schematic views of electronic devices according to an embodiment of the present disclosure.

Referring to FIG. 2, various electronic devices to which the display device according to an embodiment is applied may include an image display electronic device such as a smartphone 10_1a, a tablet personal computer (PC) 10_1b, a laptop computer 10_1c, a television (TV) 10_1d, and a desk monitor 10_1e, a wearable electronic device including a display module such as a smart glasses 10_2a, a head mounted display 10_2b, and a smart watch 10_2c, and a vehicle electronic device 10_3 including a display module such as an instrument panel, a center fascia, a center information display (CID) disposed on a dashboard, and a room mirror display of a vehicle.

In an embodiment, the electronic device may include a display device that displays an image and a processor that processes an image signal and provides the image signal to the display device.

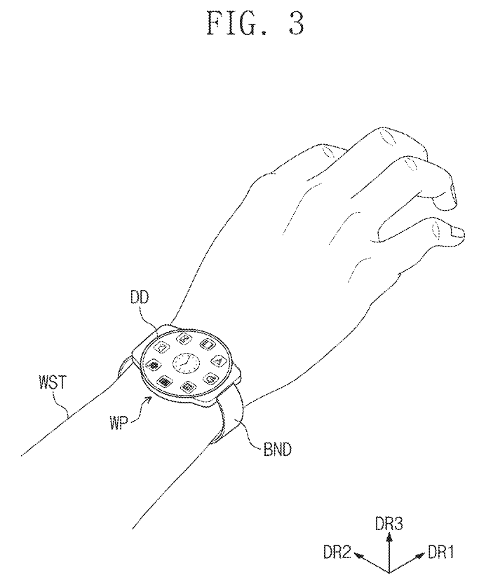

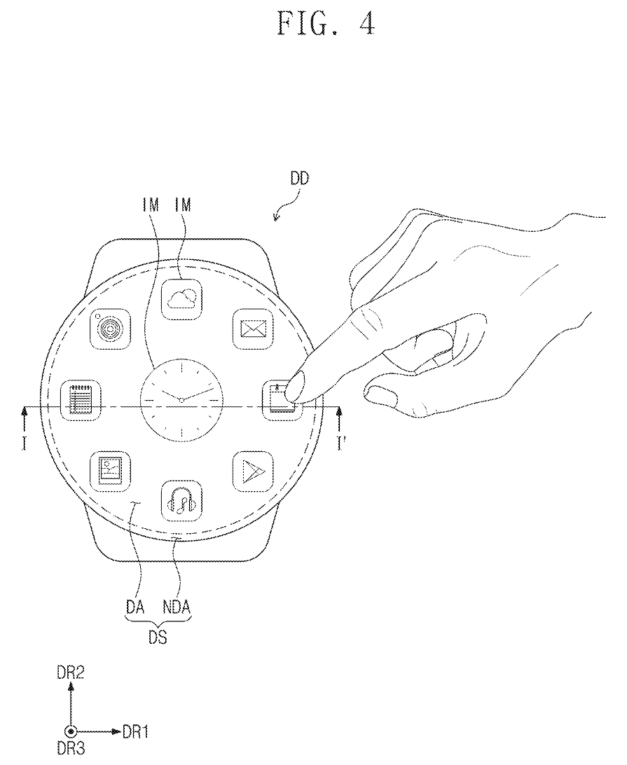

FIG. 3 is a view illustrating a wearable electronic device including a display device according to an embodiment of the present disclosure. FIG. 4 is a view illustrating a plane of the display device of the wearable electronic device illustrated in FIG. 3.

Referring to FIGS. 3 and 4, a user may use a wearable electronic device (e.g., a smart watch) WP while wearing the wearable electronic device WP on a wrist WST of the user. The wearable electronic device WP may include a display device DD and a band BND connected to the display device DD. The user may arrange the band BND around the wrist WST to wear the wearable electronic device phone WP on the wrist WST. The display device DD may be disposed toward the user.

The wearable electronic device WP may provide various images IM to the user. The images IM may represent a time and various applications. In an embodiment, for example, the display device DD of the wearable electronic device WP may display an hour hand and a minute hand indicating a time and provide the hour hand and the minute hand to the user. Further, the display device DD may display various applications and provide the applications to the user.

The display device DD may be a touch-type display device. In an embodiment, for example, when the user touches applications displayed on the display device DD, the touched applications may be executed. . In an embodiment, for example, when the user touches a weather application among the applications displayed on the display device DD, weather information may be provided to the user.

An upper surface of the display device DD may be defined as a display surface DS and may have a plane defined by a first direction DR1 and a second direction DR2. The first direction DR1 and the second direction DR2 may be defined as directions perpendicularly intersecting each other. The images IM generated by the display device DD may be provided to a user through the display surface DS.

Hereinafter, a direction substantially perpendicular to the plane defined by the first direction DR1 and the second direction DR2 is defined as a third direction DR3. Further, in the specification, the wording "when viewed on a plane” or “in a plan view” may be defined as a state of being viewed from the third direction DR3. The third direction DR3 may be a thickness direction of the display device DD.

The display surface DS may include a display area DA and a non-display area NDA around the display area DA. The display area DA displays an image, and the non-display area NDA does not display the image. The non-display area NDA may surround the display area DA and define an edge of the display device DD, which is printed in a predetermined color.

When viewed on a plane (or in a plan view), an embodiment of the display device DD may have a circular shape, but the present disclosure is not limited thereto, and the display device DD may have various shapes such as a quadrangular shape, a polygonal shape, or an elliptic shape.

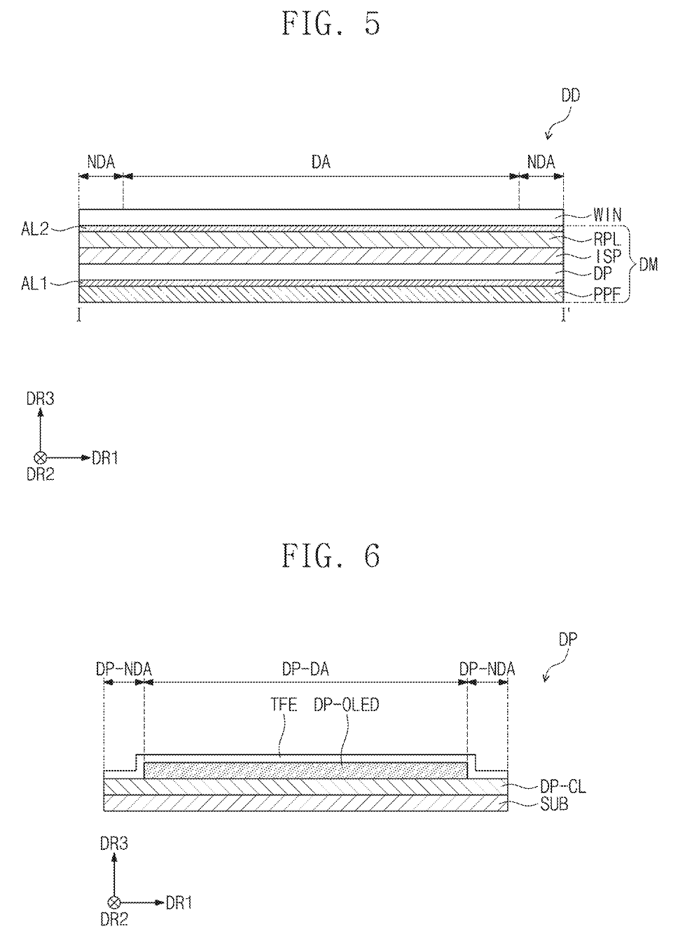

FIG. 5 is a view illustrating, by way of example, a cross section along line I-I′ of the display device illustrated in FIG. 4.

By way of example, FIG. 5 is a cross-sectional view of the display device DD when viewed in the second direction DR2.

Referring to FIG. 5, an embodiment of the display device DD may include the display module DM and a window WIN. The display module DM may include a display panel DP, an input sensing unit ISP, a reflection preventing layer RPL, a panel protecting film PPF, a first adhesive layer AL1, and a second adhesive layer AL2.

The display panel DP may be a flexible display panel. The display panel DP according to an embodiment of the present disclosure may be a light emitting display panel, but the present disclosure is not particularly limited thereto. In an embodiment, for example, the display panel DP may be an organic light emitting display panel or an inorganic light emitting display panel. A light emitting layer of the organic light emitting display panel may include an organic light emitting material. A light emitting layer of the inorganic light emitting display panel may include a quantum dot and a quantum rod. Hereinafter, for convenience of description, embodiments where the display panel DP is an organic light emitting display panel will be mainly described.

The input sensing unit ISP may be disposed on the display panel DP. The input sensing unit ISP may include a plurality of sensor units for sensing an external input in a capacitive manner. In an embodiment, the input sensing unit ISP may be directly manufactured on the display panel DP when the display device DD is manufactured. However, the present disclosure is not limited thereto, and in another embodiment, the input sensing unit ISP may be manufactured as a separate panel from the display panel DP and attached to the display panel DP by an adhesive layer.

The reflection preventing layer RPL may be disposed on the input sensing unit ISP. The reflection preventing layer RPL may be defined as an external light reflection preventing film or antireflection film. The reflection preventing layer RPL may reduce a reflectance of an external light input from an upper side of the display device DD toward the display panel DP.

When an external light traveling toward the display panel DP is reflected by the display panel DP and provided back to an external user, the user may visually recognize the external light like a mirror. In an embodiment, for example, the reflection preventing layer RPL may include a plurality of color filters that display the same colors as those of the pixels of the display panel DP to prevent this phenomenon.

In such an embodiment, the color filters may filter the external light into the same colors as those of the pixels. In such an embodiment, the external light may not be visually recognized by the user. When the display device DD is manufactured, the reflection preventing layer RPL including the color filters may be directly manufactured on the input sensing unit ISP.

Alternatively, the reflection preventing layer RPL may include a polarizing film including a retarder and/or a polarizer to reduce a reflectance of an external light. The reflection preventing layer RPL including the polarizing film may be manufactured as a separate panel from the input sensing unit ISP and attached to the input sensing unit ISP by an adhesive layer.

The window WIN may be disposed on the reflection preventing layer RPL. The window WIN may protect the display panel DP, the input sensing unit ISP, and the reflection preventing layer RPL from external scratches and impacts.

The panel protecting film PPF may be disposed under the display panel DP. The panel protecting film PPF may protect a lower portion of the display panel DP. The panel protecting film PPF may include a flexible plastic material such as polyethyleneterephthalate (PET).

The first adhesive layer AL1 may be disposed between the display panel DP and the panel protecting film PPF, and the display panel DP and the panel protecting film PPF may adhere to each other by the first adhesive layer AL1. The second adhesive layer AL2 may be disposed between the reflection preventing layer RPL and the window WIN, and the reflection preventing layer RPL and the window WIN may be combined to each other by the second adhesive layer AL2.

FIG. 6 is a view illustrating, by way of example, a cross section of a display panel illustrated in FIG. 5.

By way of example, FIG. 6 illustrates a cross section of the display panel DP when viewed in the second direction DR2.

Referring to FIG. 6, an embodiment of the display panel DP may include a substrate SUB, a circuit element layer DP-CL disposed on the substrate SUB, a display element layer DP-OLED disposed on the circuit element layer DP-CL, and a thin film encapsulation layer TFE disposed on the display element layer DP-OLED.

The substrate SUB may include a display area DP-DA and a non-display area DP-NDA around the display area DP-DA. The substrate SUB may include glass or a flexible plastic material such as polyimide (PI). The display element layer DP-OLED may be disposed on the display area DP-DA.

A plurality of pixels may be arranged in the circuit element layer DP-CL and the display element layer DP-OLED. Each of the pixels may include a transistor disposed on the circuit element layer DP-CL and a light emitting element disposed on the display element layer DP-OLED and connected to the transistor. A configuration of the pixel will be described below in detail.

The thin film encapsulation layer TFE may be disposed on the circuit element layer DP-CL to cover the display element layer DP-OLED. The thin film encapsulation layer TFE may protect the pixels from moisture, oxygen, and external foreign substances.

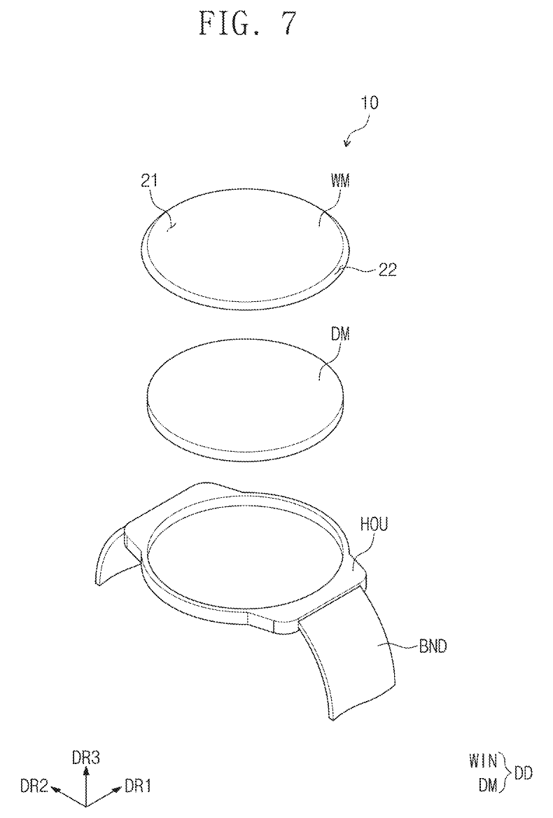

FIG. 7 is an exploded perspective view of the electronic device according to an embodiment of the present disclosure.

Referring to FIG. 7, an embodiment of the electronic device 10 may include the window WIN, the display module DM, a housing HOU, and the band BND.

The window WIN may be disposed on the display module DM to protect the display module DM. The window WIN may transmit light emitted from the display module DM. The window WIN may include a transparent plastic material, a glass material, or a reinforced glass material. In an embodiment, the window WIN may have any one of sapphire glass and gorilla glass or a laminated structure thereof. In an embodiment, the window WIN may include at least one material selected from polyethylene terephthalate (PET), polycarbonate (PC), polyethersulfone (PES), polyethyleneaphthalate (PEN), and polynorbornene (PNB). In an embodiment, the window WIN may include or be made of reinforced glass in consideration of scratches and transparency.

The window WIN may be disposed to overlap the display module DM and cover a front surface of the display module DM. The window WIN may generally have a shape similar to that of the display module DM on a plane, but a size thereof may be larger than that of the display module DM. In an embodiment, for example, the window WIN may protrude outward from the display module DM. A planar shape of the window WIN may be a circular shape, and a three-dimensional shape thereof may be a dome shape. The present disclosure is not limited thereto, and the window WIN may have various shapes and may have, for example, a polygonal shape such as a quadrangular shape or an elliptic shape.

The window WIN may include a central portion 21 and a curved portion (or curved edge portion) 22. The central portion 21 may be located at a center of the window WIN and may be generally flat. In an embodiment, the central portion 21 may be an area corresponding to the display area DA (see FIG. 4) of the display device DD. In an embodiment, the central portion 21 of the window WIN may cover the entire display area DA, but the present disclosure is not limited thereto, and in another embodiment, for example, the central portion 21 may cover only a portion of the display area DA.

The curved portion 22 may be disposed around the central portion 21. The curved portion 22 may be disposed to surround the central portion 21. The curved portion 22 may be a portion bent from the central portion 21. The curved portion 22 may be bent from an edge of the central portion 21. In an embodiment, a portion of the curved portion 22 may include a curved surface having a curvature, and the other portion thereof may be flat. In an embodiment, a degree (or an angle) by which the curved portion 22 is bent from the central portion 21 may be an obtuse angle, but the present disclosure is not limited thereto, and in another embodiment, the degree (or the angle) may be a right angle or an acute angle.

The curved portion 22 may include a curved surface having a curvature. In an embodiment, the curvature of the curved portion 22 may be constant for areas, but the present disclosure is not limited thereto, and in another embodiment, the curvature may be different for areas. In an embodiment, for example, the curved portion 22 may have a curved shape and may be inclined at a constant angle, for example, about 120 degrees, from the central portion 21. The constant angle may be defined by an angle formed between an inner surface of the central portion 21 and an inner surface of the curved portion 22. Accordingly, the curved portion 22 may be curved in a curved shape from the central portion 21 and thus may be expressed as a three-dimensional window or a three-dimensional sidewall window.

The housing HOU may be disposed on an outermost rear surface of the electronic device 10, may include at least one selected from a plastic material, a metal material, and a glass material, and may include a color coating layer. In an embodiment, the housing HOU may be a flat glass having a transparent, semi-transparent, or opaque color coating layer.

The housing HOU may have a same shape as the window WIN and may include a glass material having a color coating layer. In an embodiment, for example, the housing HOU may have a structure symmetrical to the window WIN and may include a transparent, semi-transparent, or opaque color coating layer.

The band BND may be a portion for fixing a combination of the window WIN, the display module DM, and the housing HOU to the wrist WST of the user or the like as described above with reference to FIG. 3. In an embodiment, for example, the band BND may be any one of a strap, a chain, and a bracelet.

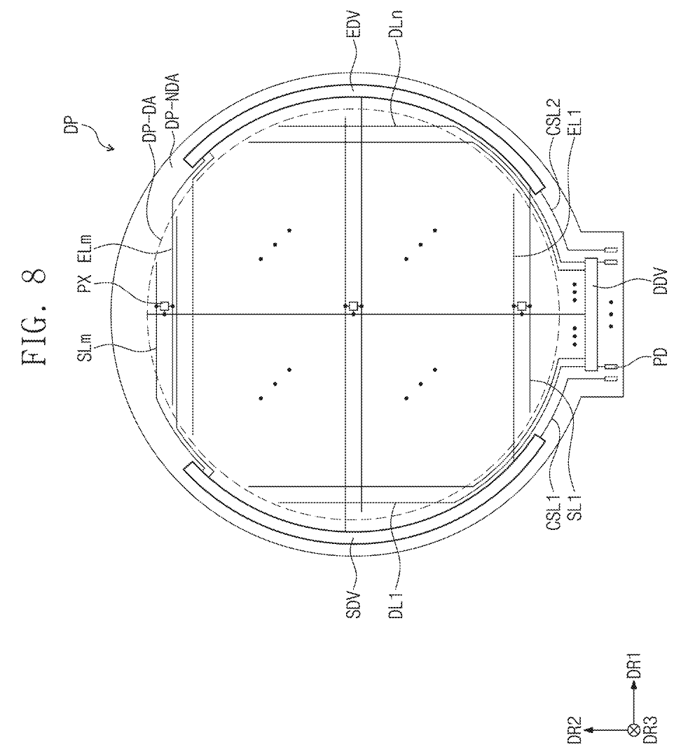

FIG. 8 is a plan view of the display panel illustrated in FIG. 5.

Referring to FIG. 8, an embodiment of the display device DD may include the display panel DP, a scan driver SDV, a data driver DDV, a light emission driver EDV, and pads PD.

The display panel DP may have a circular shape, but the shape of the display panel DP is not limited thereto. In an embodiment, for example, where the display panel DP has a circular shape, a lower end of the display panel DP may protrude downward to have a quadrangular shape. The display panel DP may include the display area DP-DA and the non-display area DP-NDA around the display area DP-DA. The display area DP-DA may have a circular shape. The non-display area DP-NDA may surround the display area DP-DA.

The display panel DP may include a plurality of pixels PX, a plurality of scan lines SL1 to SLm, a plurality of data lines DL1 to DLn, a plurality of light emitting lines EL1 to ELm, a first control line CSL1, and a second control line CSL2. Here, “m” and “n” are natural numbers greater than 1.

The pixels PX may be arranged in the display area DP-DA. The scan driver SDV and the light emission driver EDV may be arranged in the non-display area DP-NDA adjacent to opposite sides of the display panel DP, which are opposite to each other in the first direction DR1. The data driver DDV may be disposed in the non-display area DP-NDA adjacent to one of opposite sides of the display panel DP, which are opposite to each other in the second direction DR2. When viewed on a plane or in a plan view, the data driver DDV may be adjacent to the lower end of the display panel DP.

The scan lines SL1 to SLm may extend in the first direction DR1 and may be connected to the pixels PX and the scan driver SDV. The data lines DL1 to DLn may extend in the second direction DR2 and may be connected to the pixels PX and the data driver DDV. The light emitting lines EL1 to ELm may extend in the first direction DR1 and may be connected to the pixels PX and the light emission driver EDV. The pixels PX may be arranged in areas defined based on the scan lines SL1 to SLm, the data lines DL1 to DLn, and the light emitting lines EL1 to ELm.

The first control line CSL1 may be connected to the scan driver SDV and extend toward the lower end of the display panel DP. The second control line CSL2 may be connected to the light emission driver EDV and extend toward the lower end of the display panel DP. The data driver DDV may be disposed between the first control line CSL1 and the second control line CSL2.

The pads PD may be arranged in the non-display area DP-NDA adjacent to the lower end of the display panel DP and may be closer to the lower end of the display panel DP than the data driver DDV. The data driver DDV, the first control line CSL1, and the second control line CSL2 may be connected to the pads PD. The data lines DL1 to DLn may be connected to the data driver DDV, and the data driver DDV may be connected to the pads PD corresponding to the data lines DL1 to DLn.

A scan control signal may be provided to the scan driver SDV through the first control line CSL1. A light emitting control signal may be provided to the light emission driver EDV through the second control line CSL2. A data control signal may be provided to the data driver DDV.

The scan driver SDV may generate a plurality of scan signals in response to the scan control signal. The scan signals may be applied to the pixels PX through the scan lines SL1 to SLm. The scan signals may be sequentially applied to the pixels PX.

The data driver DDV may generate a plurality of data voltages corresponding to image signals in response to the data control signal. The data voltages may be applied to the pixels PX through the data lines DL1 to DLn. The light emission driver EDV may generate a plurality of light emitting signals in response to the light emitting control signal. The light emitting signals may be applied to the pixels PX through the light emitting lines EL1 to ELm.

The pixels PX may receive the data voltages in response to the scan signals. The pixels PX may display an image by emitting light having brightness corresponding to the data voltages in response to the light emitting signals.

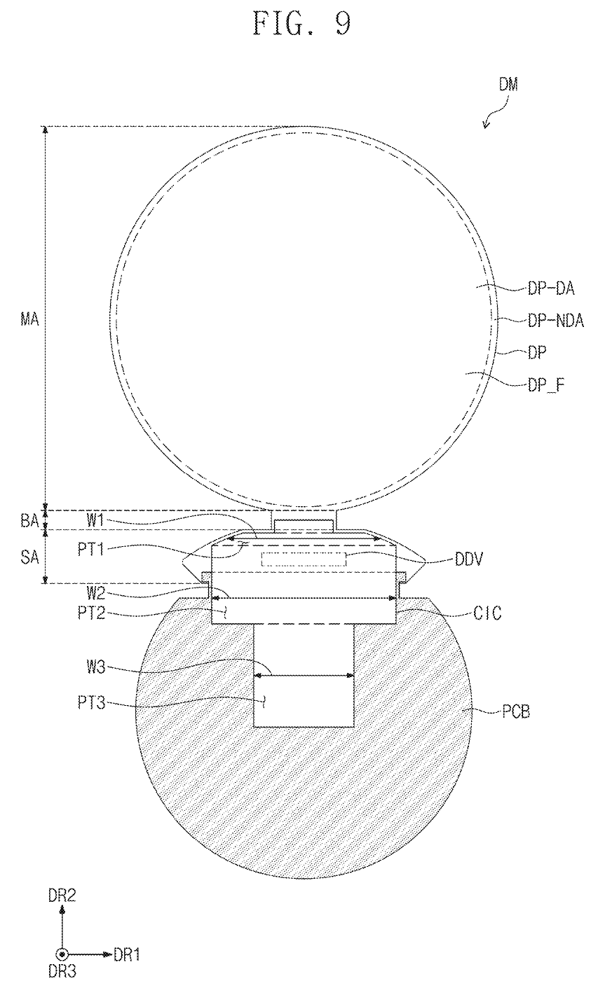

FIG. 9 is a front view illustrating a display module in an unfolded state according to an embodiment of the present disclosure. FIG. 9 illustrates that a front surface DP_F of the display panel DP faces a front surface.

Referring to FIG. 9, an embodiment of the display module DM may include the display panel DP, the data driver DDV, a cover film CIC, and a flexible circuit board PCB.

The display panel DP may include the display area DP-DA and the non-display area DP-NDA. In an embodiment, the display area DP-DA of the display panel DP may have a circular shape when viewed on a plane or in a plan view. However, the present disclosure is not limited thereto, and the display area DP-DA may have various shapes such as a rectangular shape, a rectangular shape having rounded corners, a square, other polygonal shapes, or an elliptic shape.

The non-display area DP-NDA may be disposed around the display area DP-DA. The non-display area DP-NDA may be a bezel area. In an embodiment, the non-display area DP-NDA may surround the display area DP-DA. However, the present disclosure is not limited thereto, and in an anther embodiment, for example, the non-display area DP-NDA may not be disposed in at least portions of peripheral areas of the display area DP-DA.

In an embodiment, the display panel DP may include a flexible substrate including a flexible polymer material such as polyimide. Accordingly, in such an embodiment, the display panel DP may be bent, curved, folded, or rolled.

The display panel DP may include a main area MA, a bending area BA, and a sub-area SA. The bending area BA may be disposed between the main area MA and the sub-area SA in the second direction DR2. The main area MA may be disposed on one side of the bending area BA in the second direction DR2. The sub-area SA may be disposed on the other side of the bending area BA in the second direction DR2.

The display area DP-DA and the non-display area DP-NDA of the display panel DP may be arranged inside the main area MA. In an embodiment, among the main area MA, a peripheral edge portion of the display area DP-DA, the entire bending area BA, and the entire sub-area SA may be the non-display area DP-NDA. However, the present disclosure is not limited thereto, and in another embodiment, the bending area BA and/or the sub-area SA may also include the display area DP-DA.

The main area MA may generally have a shape similar to an outer shape of the display panel DP on a plane. In an embodiment, the main area MA may be a flat area located on one plane. However, the present disclosure is not limited thereto, and in another embodiment, for example, at least some of edges of the main area MA may be bent in the third direction DR3 to form a curved surface or may be bent in a vertical direction.

When at least some of the edges of the main area MA are bent in the third direction DR3 to form the curved surface or are bent in the vertical direction, the display area DP-DA may also be disposed on the corresponding edge. However, the present disclosure is not limited thereto, and the curved or bent edge may be a non-display area that does not display a screen or a display area and a non-display area may be mixedly present in the corresponding area.

The bending area BA may be connected to the other side of the main area MA in the second direction DR2. In an embodiment, for example, the bending area BA may be connected through a lower short side of the main area MA. A width of the bending area BA, e.g., a width thereof in the first direction DR1, may be smaller than a width of the main area MA adjacent to the bending area BA, e.g., a width thereof in the first direction DR1. A connection portion between the main area MA and the bending area BA may have an L-shaped cutting shape.

In an embodiment, the cover film CIC may include a first portion PT1, a second portion PT2, and a third portion PT3.

The first portion PT1 may be adjacent to the bending area BA and may have a first width W1. The first width W1 may have a value that is continuously changed in the second direction DR2. The first width W1 may decrease as it approaches (or being toward) a center of the display panel DP. That is, the first width W1 may decrease in the second direction DR2.

The second portion PT2 may extend from the first portion PT1. The second portion PT2 may be defined in a direction opposite to the second direction DR2 from the first portion PT1. The second portion PT2 may have a second width W2. The second width W2 may be constant.

The third portion PT3 may extend from the second portion PT2. The third portion PT3 may be defined in a direction opposite to the second direction DR2 from the second portion PT2. The third portion PT3 may have a third width W3. The third width W3 may be constant. The third width W3 may be smaller than the second width W2.

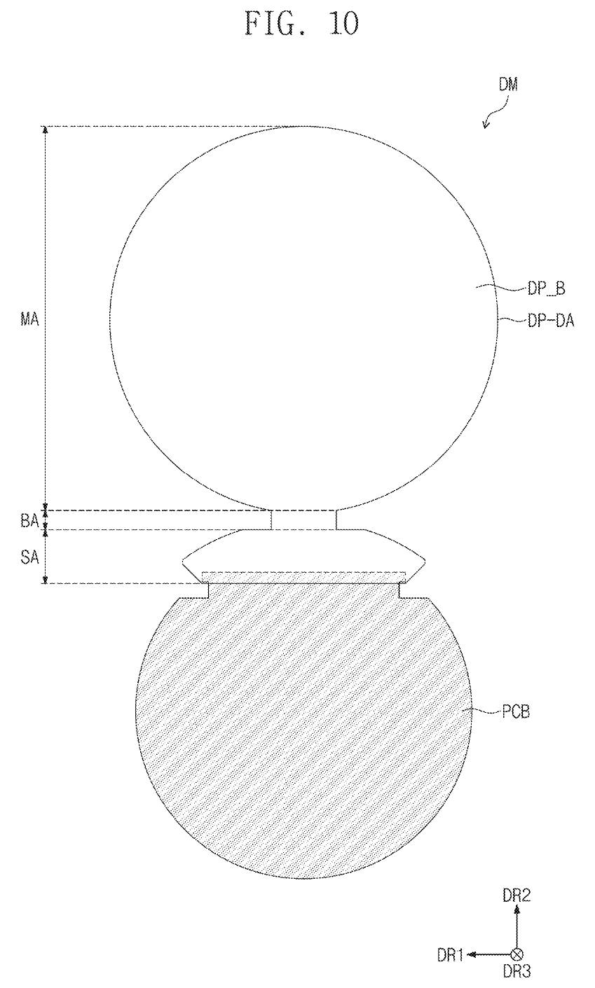

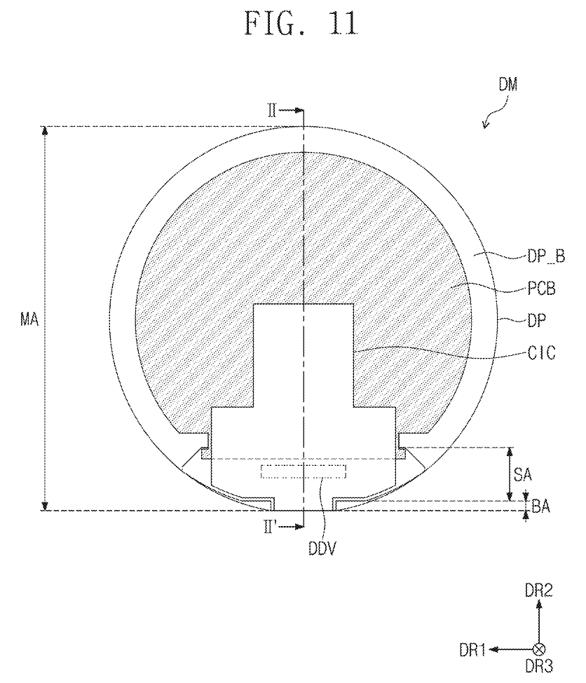

FIG. 10 is a rear view illustrating the display module in an unfolded state according to an embodiment of the present disclosure. FIG. 11 is a rear view illustrating the display module in a bent state according to an embodiment of the present disclosure.

Referring to FIGS. 9 to 11, the bending area BA may be an area in which the display panel DP is bent. In the bending area BA, the display panel DP may be bent to have a curvature that is downward in a thickness direction. In an embodiment, for example, in the bending area BA, the display panel DP may be bent in a direction opposite to the third direction DR3.

In an embodiment, the bending area BA may have a constant radius of curvature, but the present disclosure is not limited thereto, and in another embodiment, the bending area BA may have different radii of curvature for sections. As the display panel DP is bent in the bending area BA, a surface of the display panel DP may be inverted. In an embodiment, for example, the display panel DP may be bent in a direction opposite to the front surface DP_F of the display panel DP, which is a display surface.

The sub-area SA may be disposed in a direction opposite to the second direction DR2 from the bending area BA. The sub-area SA may extend from the bending area BA in a direction opposite to the second direction DR2. A width of the sub-area SA, e.g., a width thereof in the first direction DR1, may be greater than a width of the bending area BA, e.g., a width thereof in the first direction DR1. A connection portion between the sub-area SA and the bending area BA may have an L-shaped cutting shape.

A size of the sub-area SA may be smaller than a size of the main area MA of the display panel DP. In an embodiment, for example, as illustrated in FIG. 11, in a state in which the display panel DP is bent, the sub-area SA may completely overlap the main area MA, that is, an entire portion of the sub-area SA may overlap the main area. In a state in which the display panel DP is bent, an outline of the sub-area SA may be surrounded by an outline of the main area MA on a plane. The outline of the sub-area SA may be disposed inside the outline of the main area MA on a plane.

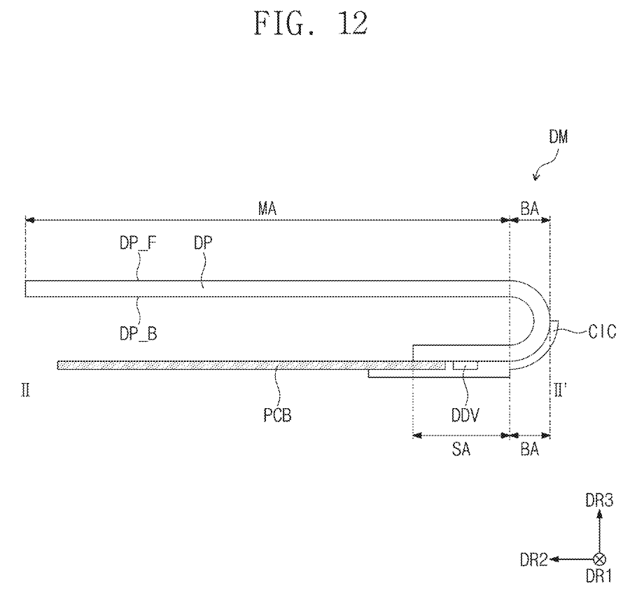

FIG. 12 is a view illustrating a cross section along line II-II′ of the display module illustrated in FIG. 11.

Referring to FIGS. 11 and 12, in a state in which the display panel DP is bent, the sub-area SA may overlap the main area MA in the thickness direction of the display panel DP, i.e., in the third direction DR3. The sub-area SA may be disposed at a lower portion of the main area MA in the third direction DR3.

The data driver DDV may be disposed on the sub-area SA of the display panel DP. The data driver DDV may be disposed on the front surface DP_F of the display panel DP in the sub-area SA of the display panel DP. In an embodiment, as illustrated in the drawings, the data driver DDV may be directly mounted on the display panel DP in a chip-on-glass (COG) method or a chip-on-plastic (COP) method. In an embodiment, the data driver DDV may be mounted on a flexible film in a chip-on-film (COF) method.

The data driver DDV may generate and output the data voltages, power voltages, scan timing signals, and the like. The data driver DDV may include an integrated circuit that drives the display panel DP. In an embodiment, the integrated circuit may include an integrated circuit for a display and/or an integrated circuit for a touch unit. However, the present disclosure is not limited thereto, and in another embodiment, the integrated circuit for a display and the integrated circuit for a touch unit may be provided as separate chips or may be provided as a single integrated chip.

The flexible circuit board PCB may be disposed on a portion of the sub-area SA of the display panel DP. The pads PD (see FIG. 8) may be arranged at a portion of the sub-area SA of the display panel DP. The pads PD may include a plurality of display signal wiring line pads and a touch signal wiring line pad. The flexible circuit board PCB may be connected to the pads PD of a portion of the sub-area SA of the display panel DP.

The flexible circuit board PCB may be attached onto the pads PD using a conductive adhesive member such as an anisotropic conductive film and an anisotropic conductive adhesive. The flexible circuit board PCB may be a flexible film such as a flexible printed circuit board or a COF.

In a state in which the display panel DP is bent, the data driver DDV and the flexible circuit board PCB may be located on an opposite side of the display panel DP of the main area MA with the display panel DP of the sub-area SA interposed therebetween. That is, the data driver DDV and the flexible circuit board PCB may be arranged on the front surface DP_F of the display panel DP in the sub-area SA, and as the display panel DP is bent, the data driver DDV and the flexible circuit board PCB may be located far from a rear surface DP_B of the display panel DP in a direction opposite to the third direction DR3.

A size of the flexible circuit board PCB may be smaller than the size of the main area MA of the display panel DP. In an embodiment, for example, as illustrated in FIG. 11, in a state in which the display panel DP is bent, the flexible circuit board PCB may completely overlap the main area MA of the display panel DP. In a state in which the display panel DP is bent, an outline of the flexible circuit board PCB may be surrounded by the outline of the main area MA of the display panel DP on a plane. The outline of the flexible circuit board PCB may be disposed inside the outline of the main area MA of the display panel DP on a plane or in a plan view.

A planar shape of the flexible circuit board PCB may be substantially similar to a planar shape of the display panel DP. In an embodiment, for example, when the planar shape of the display panel DP is a circular shape, at least a portion of the flexible circuit board PCB may have a circular shape. However, the present disclosure is not limited thereto, and a shape of the flexible circuit board PCB may be variously modified.

FIGS. 13 to 20 are views illustrating a method of manufacturing an electronic device according to an embodiment of the present disclosure.

Referring to FIGS. 9 and 13, an embodiment of a method of manufacturing an electronic device may include an operation (or process) of preparing the display panel DP including the bending area BA and the sub-area SA adjacent to the bending area BA. The operation of preparing the display panel DP may include an operation of providing the display panel DP having a circular shape when viewed on a plane or in a plan view.

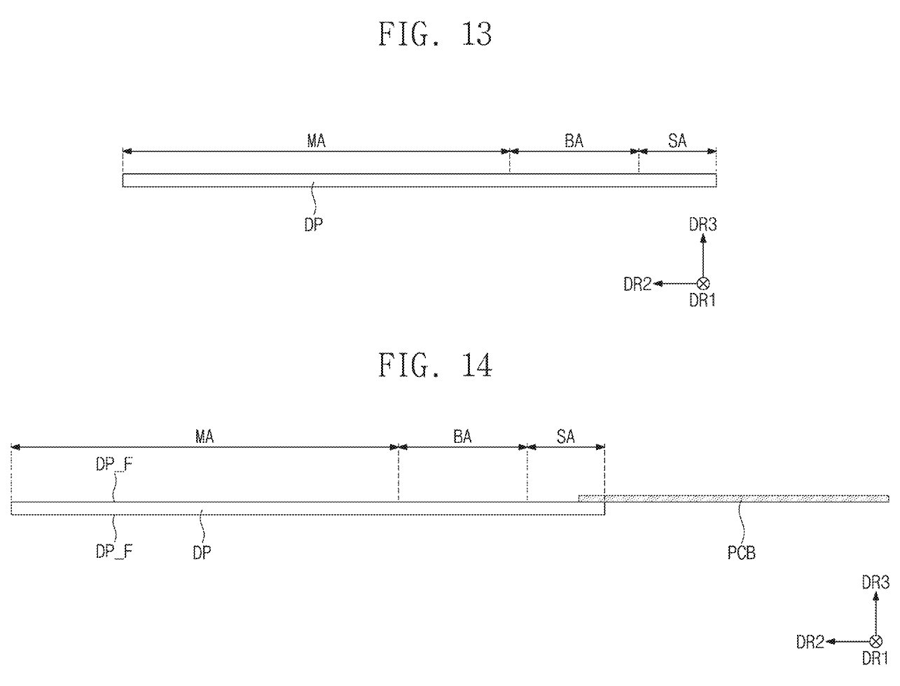

Referring to FIG. 14, an embodiment of the method of manufacturing an electronic device may include an operation of providing or arranging the flexible circuit board PCB in the sub-area SA of the display panel DP. The flexible circuit board PCB may be disposed in a portion of the sub-area SA in the front surface DP_F of the display panel DP.

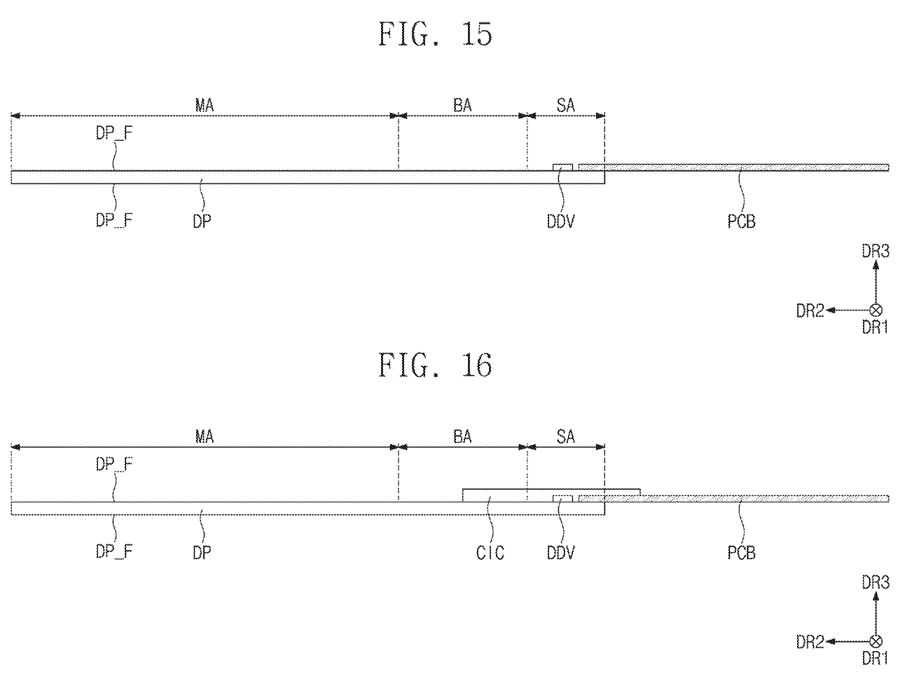

Referring to FIG. 15, an embodiment of the method of manufacturing an electronic device may include an operation of providing or arranging the data driver DDV in the sub-area SA. The data driver DDV may be disposed in the sub-area SA in the front surface DP_F of the display panel DP.

Referring to FIG. 16, an embodiment of the method of manufacturing an electronic device may include an operation of providing or disposing the cover film CIC. The cover film CIC may cover the data driver DDV. When viewed on a plane or in a plan view, the cover film CIC may overlap a portion of the bending area BA of the display panel DP. A portion of the cover film CIC may be disposed on the flexible circuit board PCB.

The cover film CIC may be disposed on the flexible circuit board PCB and the display panel DP to protect the data driver DDV from physical impact, static electricity, dust, and moisture. The cover film CIC may protect the data driver DDV from external friction or pressure. The cover film CIC may effectively prevent damage to the data driver DDV due to electrostatic discharge. The cover film CIC may eliminate a problem that may occur in a circuit wiring line of the data driver DDV due to introduction of dust or foreign substances. The cover film CIC may prevent moisture from being formed in the data driver DDV, thereby improving long-term reliability.

The cover film CIC may include a flexible plastic material such as polyethylene terephthalate (PET) or polyimide (PI). The cover film CIC may be transparent. Static preventing treatment or scratch preventing coating may be applied to a surface of the cover film CIC. The cover film CIC may be disposed on the display panel DP through an adhesive material, and may be disposed on the display panel DP without using an adhesive material.

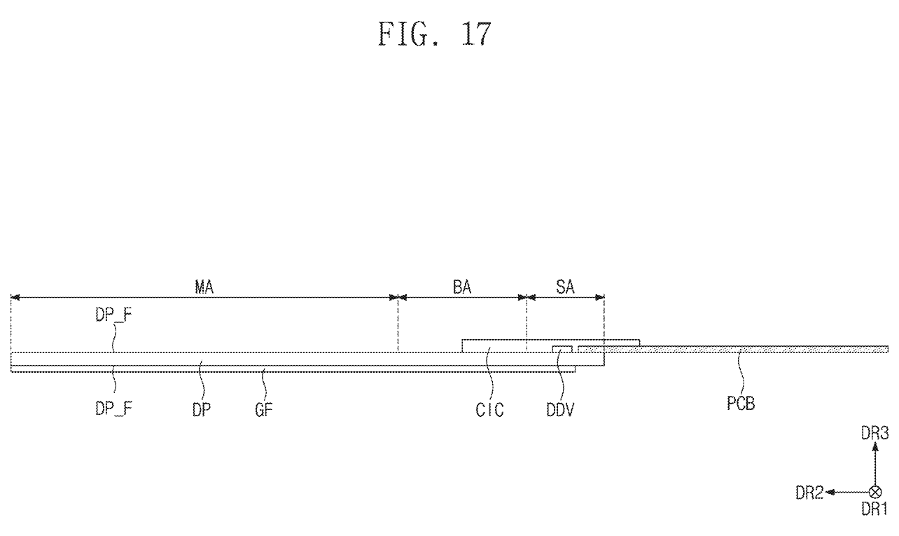

Referring to FIGS. 9 and 17, an embodiment of the method of manufacturing an electronic device may include an operation of providing or arranging a guide film GF under the display panel DP. The guide film GF may be located on a rear surface of the display panel DP. When viewed on a plane or in a plan view, the guide film GF may overlap the bending area BA and the data driver DDV.

The operation of providing or arranging the guide film GF under the display panel DP may include an operation of providing or arranging the guide film GF in a way such that the guide film GF overlaps the display area DP-DA and the non-display area DP-NDA. The guide film GF may overlap the main area MA to overlap the display area DP-DA and the non-display area DP-NDA. The operation of providing or arranging the guide film GF may include an operation of providing or arranging the guide film GF under the display panel DP in a way such that the guide film GF overlaps a portion of the cover film CIC.

A thickness of the guide film GF may be greater than 0 micrometer (μm) and less than about 50μm. The thickness of the guide film GF may be about 50μm or greater and about 100μm or less, that is, the thickness of the guide film GF may be in a range from about 50μm to about 100μm. When the guide film GF is disposed under the display panel DP, flexibility of the display panel DP may be degraded. In a process, the guide film GF may be disposed to increase a thickness of the display panel DP in the third direction DR3. The thickness of the guide film GF is not limited to be greater than 0μm and less than about 100μm as long as bending characteristics of the display panel DP are not degraded.

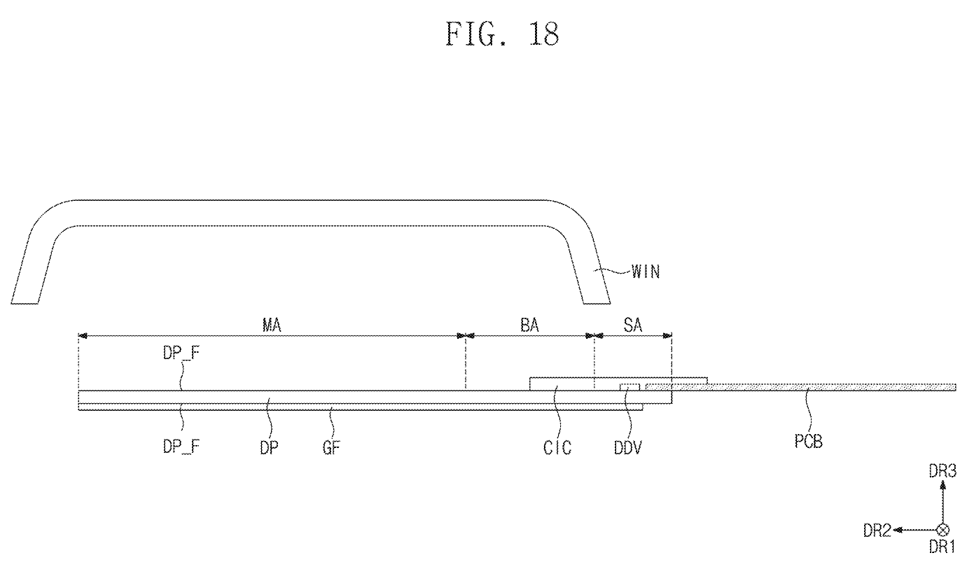

Referring to FIG. 18, an embodiment of the method of manufacturing an electronic device may include an operation of providing or arranging the dome-shaped window WIN on the display panel DP.

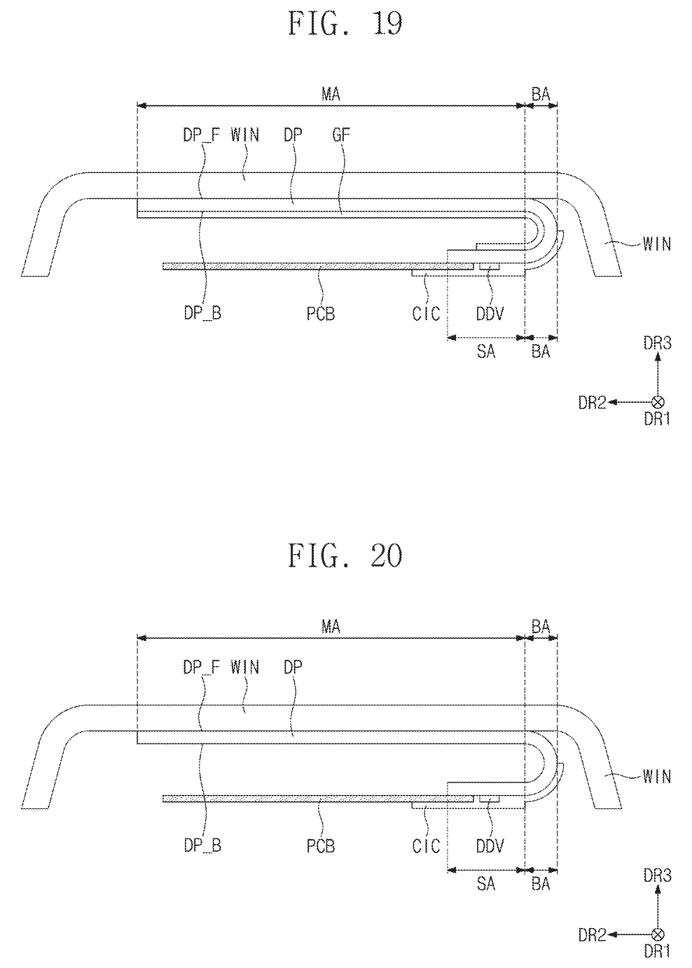

Referring to FIG. 19, an embodiment of the method of manufacturing an electronic device may include an operation of combining the display panel DP and the window WIN with each other. The display panel DP may be bent in a process of combining the display panel DP and the window WIN with each other.

When the display panel DP is bent by the window WIN, a stress may be concentrated in the bending area BA of the display panel DP. In particular, in a process of combining the dome-shaped window WIN and the display panel DP with each other, shear stress may be formed in an area in which the window WIN and the display panel DP are in contact with each other, and when the display panel DP is bent, the shear stress may cause a tensile stress in the bending area BA. This tensile stress may cause structural weakening of the display panel DP, and in severe cases, may lead to cracks or failure.

The guide film GF disposed under the display panel DP may be disposed to extend to the bending area BA and the sub-area SA to increase the thickness of the display panel DP. In an embodiment, for example, the guide film GF may be disposed to extend to a portion overlapping the cover film CIC. In a case where the guide film GF extends to the portion overlapping the cover film CIC (e.g., extends in the second direction DR2), the thickness of the bending area BA may increase, and thus a moment of inertia of the bending area BA may increase. The moment of inertia may directly affect bending stiffness of a member. As the moment of inertia increases, a tensile stress generated for the same external force may decrease.

As a result, the guide film GF may be disposed under the display panel DP, thereby improving structural stiffness, and a distribution of the tensile stress generated in the bending area BA may be alleviated, thereby reducing or removing cracks or breakages caused by the stress concentration. Accordingly, the possibility of damage to the display panel DP that may occur in the bending area BA may be effectively suppressed, and reliability of the display panel DP may be improved.

Referring to FIG. 20, an embodiment of the method of manufacturing an electronic device may include an operation of removing the guide film GF.

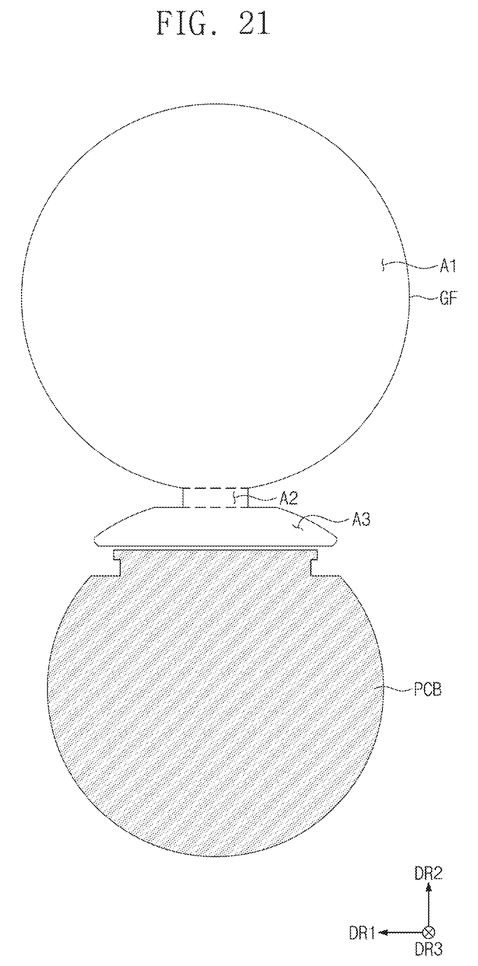

FIG. 21 is a rear view illustrating a guide film and a flexible circuit board according to an embodiment of the present disclosure.

Referring to FIGS. 9, 10, and 21, an embodiment of the guide film GF may include a first area A1, a second area A2, and a third area A3.

The first area A1 may be disposed under the display panel DP including the bending area BA and the sub-area SA adjacent to the bending area BA. The first area A1 may correspond to the main area MA. Thus, the first area A1 and the main area MA may overlap each other in the third direction DR3. The first area A1 may have a circular shape.

The second area A2 may be disposed under the display panel DP. The second area A2 may correspond to the bending area BA. Thus, the second area A2 and the bending area BA may overlap each other in the third direction DR3.

The third area A3 may be disposed under the display panel DP. The third area A3 may correspond to the sub-area SA. Thus, the third area A3 and the sub-area SA may correspond to each other in the third direction DR3. When viewed on a plane or in a plan view, the third area A3 may not overlap the bending area BA and overlap the sub-area SA.

The third area A3 may overlap the cover film CIC that overlaps the bending area BA of the display panel DP. In an embodiment, for example, the cover film CIC may be disposed on the front surface DP_F of the display panel DP. A portion of the cover film CIC and the third area A3 may overlap each other in the third direction DR3. In such an embodiment, when viewed on a plane or in a plan view, the third area A3 may overlap the data driver DDV.

As described above, a guide film disposed under a display panel is disposed to extend to a bending area and a sub-area to increase a thickness of the display panel. In a case where the guide film extends to a portion overlapping a cover film, a thickness of the bending area may increase, and thus a moment of inertia of the bending area may increase. The moment of inertia may directly affect bending stiffness of a member. As the moment of inertia increases, a tensile stress generated for the same external force may decrease.

As a result, the guide film may be disposed under the display panel, thereby improving structural stiffness, and a distribution of a tensile stress generated in the bending area may be alleviated, thereby reducing or removing cracks or breakages caused by the stress concentration. Accordingly, the possibility of damage to the display panel that may occur in the bending area may be effectively suppressed, and reliability of the display panel may be improved.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A method of manufacturing an electronic device, the method comprising:
preparing a display panel including a bending area and a sub-area adjacent to the bending area;
providing a flexible circuit board on the display panel in the sub-area;
providing a data driver on the display panel in the sub-area;
providing a cover film on the flexible circuit board to cover the data driver and to overlap the bending area of the display panel;
providing a guide film under the display panel to overlap the bending area and the data driver in a plan view;
providing a window having a dome shape on the display panel;
combining the display panel and the window with each other; and
removing the guide film.

2. The method of claim 1, wherein the display panel has a circular shape in the plan view.

3. The method of claim 1, wherein the display panel further includes a display area and a non-display area adjacent to the display area, and
wherein the providing the guide film includes:
providing the guide film to overlap the display area and the non-display area.

4. The method of claim 1, wherein the providing the guide film includes:
providing the guide film to overlap a portion of the cover film in the plan view.

5. The method of claim 1, wherein the guide film has a thickness greater than 0 μm and less than about 50 μm.

6. The method of claim 1, wherein the guide film has a thickness in a range from about 50 μm to about 100 μm.

7. The method of claim 1, wherein the cover film includes:
a first portion adjacent to the bending area and having a first width;
a second portion extending from the first portion and having a second width; and
a third portion extending from the second portion and having a third width, and
wherein the first width decreases as the first portion approaches a center of the display panel.

8. The method of claim 7, wherein each of the second width and the third width is constant.

9. The method of claim 7, wherein the third width is smaller than the second width.

10. A guide film comprising:
a first area disposed under a display panel including a bending area and a sub-area adjacent to the bending area and having a circular shape;
a second area disposed under the display panel and overlapping the bending area in a plan view; and
a third area disposed under the display panel, not overlapping the bending area , and overlapping the sub-area in the plan view.

11. The guide film of claim 10, wherein the display panel includes a display area and a non-display area adjacent to the display area, and
wherein the guide film overlaps the display area and the non-display area in the plan view.

12. The guide film of claim 10, wherein the third area overlaps a data driver disposed in the sub-area of the display panel in the plan view.

13. The guide film of claim 10, wherein the guide film has a thickness greater than 0 μm and less than about 50 μm.

14. The guide film of claim 10, wherein the guide film has a thickness in a range from about 50 μm to about 100 μm.

15. The guide film of claim 10, wherein the third area overlaps a cover film overlapping the bending area of the display panel in the plan view.

16. The guide film of claim 15, wherein the cover film includes:
a first portion adjacent to the bending area and having a first width;
a second portion extending from the first portion and having a second width; and
a third portion extending from the second portion and having a third width, and
wherein the first width decreases as the first portion approaches a center of the display panel.

17. The guide film of claim 16, wherein the second width and the third width are constant, and the third width is smaller than the second width.

18. An electronic device comprising:
a display device which displays an image; and
a processor which processes an image signal and provides the image signal to the display device,
wherein the display device is manufactured by:
preparing a display panel including a bending area and a sub-area adjacent to the bending area;
providing a flexible circuit board on the display panel in the sub-area;
providing a data driver on the display panel in the sub-area;
providing a cover film on the flexible circuit board to cover the data driver and to overlap the bending area of the display panel;
providing a guide film under the display panel to overlap the bending area and the data driver in a plan view;
providing a window having a dome shape on the display panel;
combining the display panel and the window with each other; and
removing the guide film.
